(19) United States
(12) Patent Application Publication
(10) Pub. No.: US 2013/0132879 A1
(43) Pub. Date: May 23, 2013

(54) OPERATING PANEL FOR AN UNINTERRUPTIBLE POWER SYSTEM AND OPERATING METHOD THEREOF

(71) Applicants: PO-CHIANG HSU, TAIPEI (TW); SHIH-FENG CHIU, TAIPEI (TW); SHOU-TING YEH, TAIPEI (TW)

(72) Inventors: PO-CHIANG HSU, TAIPEI (TW); SHIH-FENG CHIU, TAIPEI (TW); SHOU-TING YEH, TAIPEI (TW)

(73) Assignee: CYBER POWER SYSTEMS INC., TAIPEI (TW)

(21) Appl. No.: 13/299,437

(22) Filed: Nov. 18, 2011

(51) Int. Cl. G06F 3/048

(52) U.S. Cl. 715/771

(57) ABSTRACT

An operating panel of an uninterruptible power system (UPS) has multiple function buttons, a control module and an LCD display. Each of the function buttons is controlled to enter a main function when it has been pressed more than a threshold time or to perform a first action when it has been pressed less than the threshold time. The control module is connected to the multiple function buttons to determine whether any of the function buttons has been pressed more than the threshold time. The LCD display is connected to the control module to show operating information. A user of the UPS can directly choose a main function by long pressing the corresponding function button, and then further select to a particular sub-function by shortly clicking the function buttons.

### BACKGROUND OF THE INVENTION

1. Field of the Invention

The invention relates to an operating panel for an uninterruptible power system (UPS) and an operating method thereof. The operating panel provides different function keys by which users can select an interested function quickly.

2. Description of Related Art

With reference to FIGS. 3 and 4, an uninterruptible power system (UPS) often provides many sub-functions 81 categorized into several main functions 80. An operating panel 90 with operating buttons 92 to 95, such as a next button 92, a back button 93, a return button 94 and a confirm button 95 is applied to select a sub-function 81.

However, to choose an interested sub-function 81 by the operating panel 90 is inconvenient for users. For example, if the user wants to activate the sub-function 81a and 81b in different main functions 80, the following setting steps must be sequentially executed.

1. Press the next button 92 or the back button 93 to review and select a first main function 80 on the main function menu.

2. Press the confirm button 95 to enter the first main function 80.

3. Move to the interested sub-function 81a by further pressing the next button 92 or the back button 93, and then click the confirm button 95 to activate the interested sub-function 81a.

4. Press the return button 94 to leave the first main function 80.

5. Press the next button 92 or the back button 93 to select a second main function 80 and click the confirm button 95 to enter the second main function 80.

6. Move to another interested sub-function 81b by further pressing the next button 92 or the back button 93, and then click the confirm button 95 to activate the sub-function 81b.

It is noted that the user needs to repeatedly click the operating buttons 92-95 to change the sub-functions 81 and the main functions 80 in sequence. Therefore, the selection of different sub-functions 81 in the different main functions 80 involves many complex setting steps. Such operation procedure is inefficient and inconvenient for users. As the numbers of the main functions 80 or the sub-functions 81 increase, the user has to more frequently click these operating buttons 92-95 to select the particular function.

### SUMMARY OF THE INVENTION

An objective of the present invention is to provide an operating panel of an uninterruptible power system (UPS), which allows a user to select a sub-function quickly with simplified operating procedures.

The operating panel of the UPS comprises multiple function buttons, a control module and an LCD display.

Each of the function buttons is controlled to either enter a main function of the UPS when the function button has been pressed more than a threshold time or to perform a first action when the function button has been pressed less than the threshold time. The control module is connected to the multiple function buttons to determine whether any of the function buttons has been pressed more than the threshold time. The LCD display is connected to the control module to show operating information.

The user of the UPS is able to directly choose an interested main function by long pressing one of the function buttons, and then further select a particular sub-function by shortly clicking the function buttons.

Other objectives, advantages and novel features of the invention will become more apparent from the following detailed description when taken in conjunction with the accompanying drawings.

### BRIEF DESCRIPTION OF THE DRAWINGS

FIG. 1 is a plan view of an operating panel in accordance with the present invention;

FIG. 2 is a function table of the operating panel in accordance with the present invention;

FIG. 3 is a function table of a conventional UPS; and

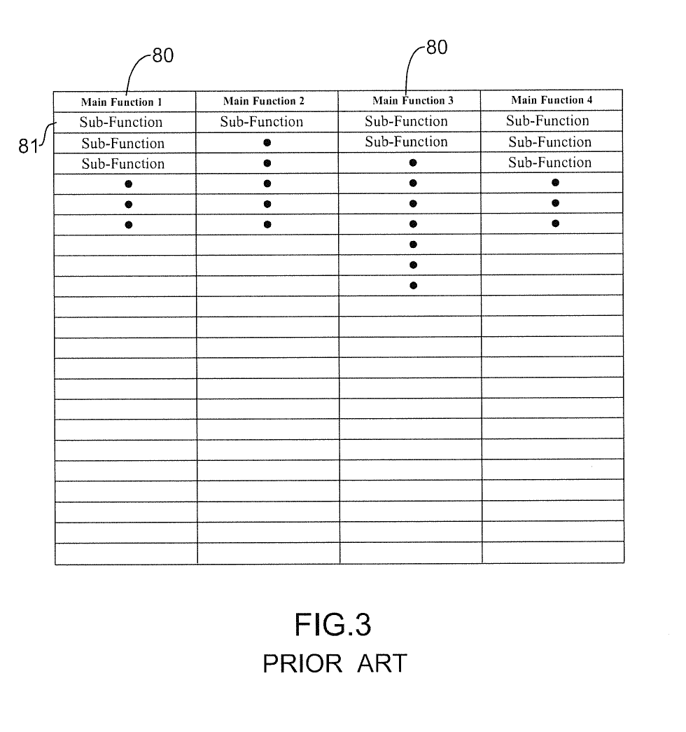

FIG. 4 is a plan view of an operating panel of a conventional UPS.

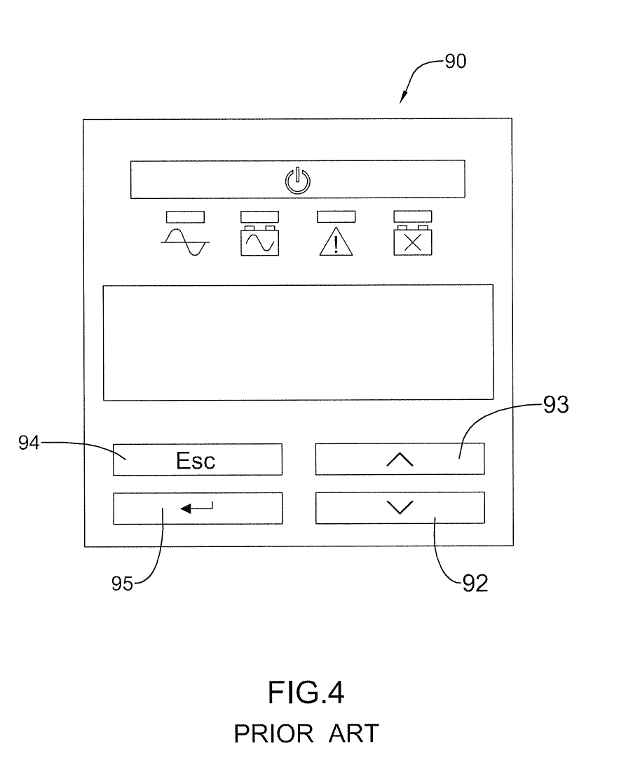

### DETAILED DESCRIPTION OF THE PREFERRED EMBODIMENT

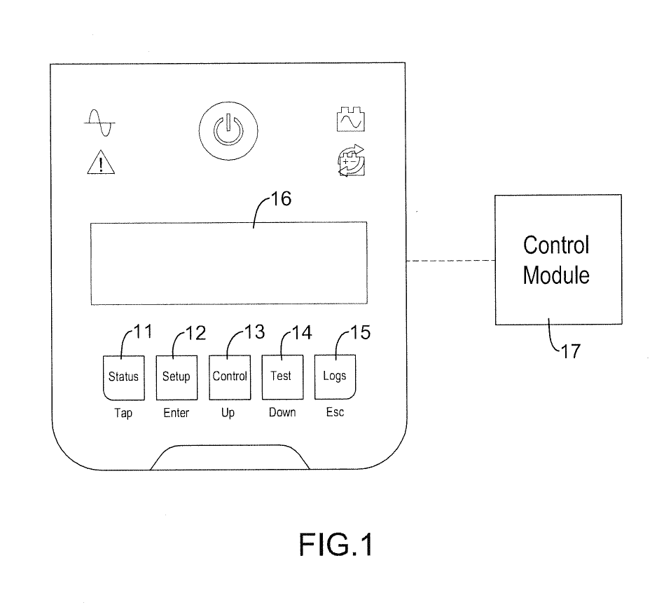

With reference to FIG. 1, an operating panel in accordance with the present invention comprises multiple function buttons 11 to 15, an LCD display 16 and a control module 17.

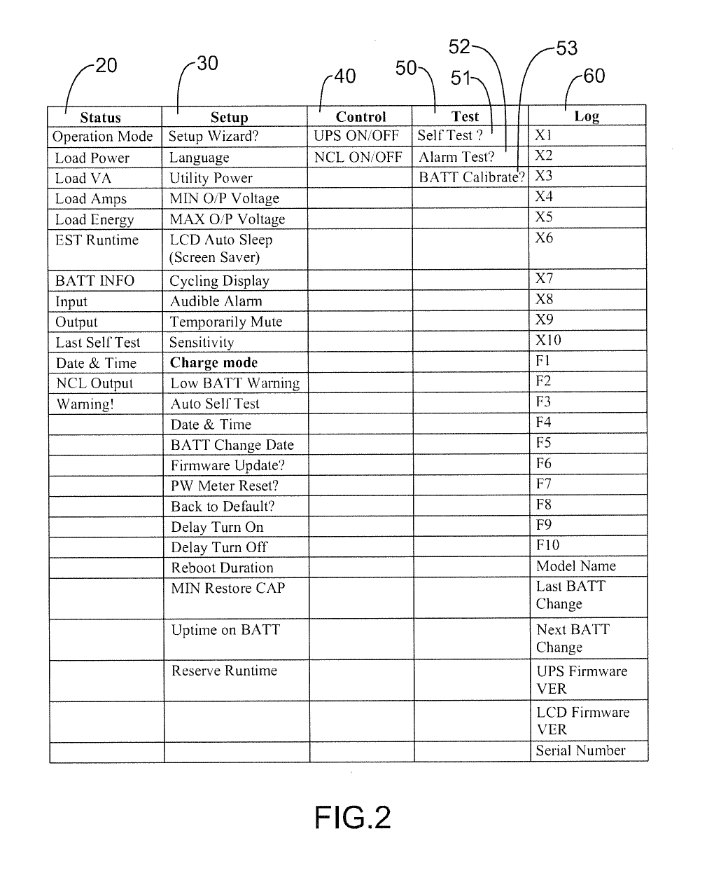

Each of the function buttons 11 to 15 is able to perform either a first action or a second action based on how long the function button 11 to 15 has been pressed. For example, the function button 11 will perform the first action unless it has been pressed more than a threshold time to execute the second action. In the embodiment, the function buttons 11 to 15 comprise a status button 11, a setup button 12, a control button 13, a test button 14 and a log button 15 respectively representing five different main functions 20, 30, 40, 50 and 60 as listed in FIG. 2.

In the present invention, the second action is to enter the main function directly. For example, when any function button 11 to 15 is pressed more than the threshold time, the UPS will enter the main function corresponding to the pressed function button.

The first action of the status button 11 is to sequentially switch the main functions, preferably indicated by “Tab”. The first action of the setup button 12 is to activate the currently selected sub-function in the main function. preferably indicated by “Enter”. The first action of the control button 13 is to switch to a previous sub-function in the main function, indicated by “Up”. The first action of the test button 14 is to switch to a subsequent sub-function in the main function, indicated by “Down”. The first action of the log button 15 is to leave or cancel a current sub-function, indicated by “Esc”.

The control module 17 detects how long each function button 11 to 15 has been pressed and then determines whether the first action or the second action should be executed.

The LCD display 16 shows control information when the user is operating the panel.

With reference to FIG. 2, each of the five main functions 20, 30, 40, 50 and 60 may further has at least one sub-function. For example, the test main function 50 includes the sub-functions of a self test 51, an alarm test 52 and a battery calibration 53.

The operating panel in accordance with present invention allows the user to select a main function 20, 30, 40, 50 and 60 directly by long pressing a corresponding function buttons 11 to 15, and then further choose a particular sub-function in the selected main function by shortly clicking the function buttons 11 to 15.

For example, when the user wants to execute the “Language” sub-function of the Setup main function 30 and the “Alarm Test” sub-function of the Test main function 50, only the following steps are performed.

1. Long pressing the setup button 12 to enter the Setup main function 30.

2. Shortly clicking the control button 13 or the test button 14 to select the “Language” sub-function and then shortly clicking the setup button to activate the “Language” sub-function.

3. Long pressing the test button 14 to enter the Test main function 50.

4. Shortly clicking the control button 13 or the test button 14 to select the “Alarm Test” sub-function and then shortly pressing the setup button 12 to activate the “Language” sub-function.

Further, the operating panel in accordance with the present invention allows a user to quickly select a Charge Mode, LCD Auto Sleep, Cycling Display, Date and Time, MIN O/P Voltage and MAX O/P Voltage, and etc. for the UPS system. As shown in FIG. 2, the Setup main function 30 includes a “Charge Mode”, “LCD Auto Sleep”, “Cycling Display”, “Date and Time”, and “MIN O/P Voltage and MAX O/P Voltage” sub-functions. Using these sub-functions, the user can select between options. For the Charge Mode, the user can choose different charge methods by selecting a Quick Charge or an ECO mode. For the LCD Auto Sleep, when UPS is operated in Line Mode, enabling the LCD Auto Sleep function can have the UPS enter an energy-saving mode (LCD turned off) if there is no activity in configured seconds. For the Cycling Display, if the buttons are not touched in few seconds, the LCD will start cycling the UPS information. For Date and Time, users can setup date and time. The function is related to Logs function. When events occur, UPS will record time and events simultaneously for users to query. For MIN O/P Voltage and MAX O/P Voltage, users can configure minimum and maximum range for output voltage. It is more intuitive compared with conventional UPS setup by input voltage.

In conclusion, the changing or moving among the different main functions or the sub-functions of the present invention is very quick and easy in comparison to the conventional operating method.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An operating panel of an uninterruptible power system (UPS) comprising:
multiple function buttons, each of the function buttons is operable to either enter a main function of the UPS when the function button has been pressed more than a threshold time or to perform a first action when the function button has been pressed less than the threshold time;
a control module connected to the multiple function buttons to determine whether any of the function buttons has been pressed more than the threshold time;
an LCD display connected to the control module to show operating information.

2. The operating panel as claimed in claim 1, wherein each main function comprises at least one sub-function, and the first actions of the function buttons are used to select one of the sub-functions.

3. The operating panel as claimed in claim 2, wherein the function buttons comprise
a status button having the first action of sequentially switching the main functions;
a setup button having the first action of activating the currently selected sub-function in the main function;
a control button having the first action of switching to a previous sub-function in the main function;
a test button having the first action of switching to a subsequent sub-function in the main function; and
a log button having the first action of leaving a current sub-function.

4. An operating method for an operating panel of an uninterruptible power system (UPS), the method comprising:
providing an operating panel having multiple function buttons;
determining whether any one of the multiple function buttons has been pressed more than a threshold time;
entering a main function associated with the function button being pressed if the function button has been pressed more than the threshold time;
performing a first action associated with the function button being pressed, if the function button has been pressed less than the threshold time, to select a sub-function of the main function.

5. The method as claimed in claim 4, wherein the first actions of the function buttons comprise:
sequentially, switching the main functions;
activating the currently selected sub-function in the main function;
switching to a previous sub-function in the main function;
switching to a subsequent sub-function in the main function; and
leaving a current sub-function.

6. The method as claimed in claim 5, wherein the main functions comprise a status function, a setup function, a control function, a test function and a log function, and the setup function further includes the sub-functions of a charge mode, an LCD auto sleep, a cycling display, a date and time, a min O/P voltage and max O/P voltage.
